(19) United States
(12) Patent Application Publication
(10) Pub. No.: US 2003/0019571 A1
(43) Pub. Date: Jan. 30, 2003

(54) Decorative surface covering and method of forming the same

(76) Inventor: Clement Zanzuri, Pinecrest, FL (US)

Correspondence Address: MALLOY & MALLOY, P.A., Historic Coral Way, 2800 S.W. Third Avenue, Miami, FL, 33129, US

(21) Appl. No.: 10/218,166

(22) Filed: Aug. 13, 2002

Related U.S. Application Data
(63) Continuation-in-part of application No. 09/777,183, filed on Feb. 5, 2001.

(51) Int. Cl. B32B 31/00

(52) U.S. Cl. 156/256; 156/293

(57) ABSTRACT

A surface covering assembly and process for the assembly and/or formation thereof, wherein the surface covering is specifically, but not exclusively, adaptable for use as a floor covering, wall covering or for the covering of other surfaces as a decorative structure. A base of reduced thickness is formed of a rigid material such as a stone-like composition and has an opening formed therein for the receipt of an inlay section with a similarly reduced thickness. The peripheries of the opening and the inlay section are correspondingly dimensioned and configured to be adjacently or contiguously disposed relative to one another to define an elongated, normally continuous seam. A backing is disposed in confronting relation to an under surface of both the base and the inlay section and is formed of an apertured construction. The correspondingly configured peripheries of the openings within the base and the inlay section are formed through the use of a high pressure stream of fluid directed onto the base and inlay section so as to configure the respective peripheries into the preferred. The fluid stream forms an area of separation within the backings of the base and inlay section. By virtue of this assembly and process the rate of cutting, utilizing the high pressure source of fluid, may be significantly increased, while still providing a precise, accurate mating or positioning of corresponding portions of the respective peripheries.

### CLAIM OF PRIORITY

The present application is a continuation-in-part application of previously filed, now pending application having Ser. No. 09/777,183, filed on Feb. 5, 2001.

### BACKGROUND OF THE INVENTION

1. Field of the Invention

This invention is directed to a surface covering assembly adaptable for use as a floor covering, wall covering or the like as well as a method of forming the covering assembly which may include a base of stone, tile or similar solid material and which may include an inlay section. Both the base and the inlay section include a backing disposed in confronting relation to an undersurface thereof and formed of a material which is separable upon the application of a high pressure fluid stream of the type used to cut portions of the base as well as the periphery of the inlay section mounted within an opening of the base. Furthermore, the surface covering is produced in a substantially economic fashion despite the fragility of the surface material and the detail or intricacy of the design by utilizing a method that significantly speeds the cutting process and assembly time, and reduces losses due to breakage despite the manufacture of a thin product.

2. Description of the Related Art

In a variety of industries involving the cutting or forming of a solid material it is necessary to perform a very detailed and precise cut in order to form intricate patterns in the solid material being processed. Such cuts are often made by directing a high pressure stream of fluid, such as but not limited too water, which may include abrasive additives, into the surface of the solid material. Naturally, many variables are involved when performing such a high precision fluid cut and accordingly, conventional systems, while at least partially automated, still require a significant amount of monitoring and estimations or judgements to be performed by an individual operator in order to assure that a desired degree of precision and quality in the cut being performed is achieved. In addition, such precision and quality need be maintained throughout the entire cutting process in order to ensure that malfunctions do not occur with the equipment being utilized or the procedure being followed.

It is well known that solid material such as stone, marble, granite, cementious material, tiles, etc. are commonly used as surface coverings and particularly coverings for exposed surfaces for both indoor and outdoor flooring. In that such materials are frequently expensive, many factors need be considered in order to ensure that a desired quality of cut is obtained. More specifically, it is not uncommon utilizing conventional techniques and procedures to encounter a degradation in quality of the cut in a middle portion of the cutting pattern. The result is the ruination of an entire, sometimes elaborate and very expensive item being formed. Depending upon the material being shaped or formed as well as the particular application which such material is intended, an operator may be required to perform any one of a variety of different grades of precision in the cut being performed. Typically, numerous cutting grades are available depending on the intended application of the article being process. By way of example, an elaborate and decorative inlay system involving relatively intricate perimeter cuts frequently requires a higher degree of cut quality to ensure that inlay sections or mating portions of the product being formed fit together properly. Conversely, many other applications do not necessitate a high quality or precision cut being formed thereby allowing the operator to perform a relatively rough quality of cut. Naturally, it is important to ensure that at least a minimum desired quality is maintained, however, cutting to an excessive quality then is needed does not add any significant or practical benefit.

It is well recognized in the cutting industry of the quality of the cut being performed is directly related to the speed of the cut or the rate at which the highly pressurized stream of fluid and aggregate mixture is directed onto the solid material being shaped. Accordingly, when processing the higher grade, more expensive materials, of the type set forth above, and/or when the product comprises the aforementioned inlaid portions or sections and/or intricate peripheral cuts, a slower cutting process is normally required. The implementation of a faster cutting rate, when forming the products of the type set forth above would result in relatively imprecise cut and further render the mounting and/or positioning of various products, including the inlaid sections, relative to one another difficult or impossible and/or present and un-acceptable appearance at the junction of such mated components.

In order to overcome the problems and disadvantages of the type set forth above, the cutting industry has attempted to develop technology, to regulate, monitor and best determine the preferred cutting rate to be utilized for a particular type of material and application. Even with the existence of improved technological advancements, the consistent obtaining of a particular quality cut is difficult and unreliable. Specifically, presently available charts and list only provide general guidelines for the desired rate to be used for a selected cut quality. However, these values are only guidelines that can vary greatly depending on a variety of factors present within the cutting process. For example, the type of cut, the type of material and even the quality of certain portions of a single slab or of different sections of the same material can vary. Such factors commonly alter the quality of the cut that is achieve0d throughout the entire cutting process. An additional disadvantage associated with present fluid cutting technologies relates to the need for constant monitoring of the system in order to accomplish the degree of quality desired throughout the entire cutting procedure. Such monitoring is at least partially concentrated on maintaining a desired cutting rate in order to accomplish the quality of cut required. The degree of monitoring necessary therefore requires frequent maintenance, repair and replacement of the equipment utilized as well as supervisory personnel being present during the entire cutting or shaping procedure.

Because of the above set forth disadvantages and problems, commonly recognized in the fluid cutting industry, it would be highly beneficial to eliminate the necessity of regulating the speed of a fluid cut or the time and personnel involved in the continuous monitoring of fluid cuts during the entire cutting procedure. Rather than further modify the apparatus utilized in this industry, it would be more beneficial to develop a product, such as, but not limited to, a surface covering assembly which would be adaptable for use as floor coverings, wall coverings, etc. Such an improved surface covering could be highly decorative including one or more inlay sections or components which require peripheral cuts. Further a product of the type described and a method of forming such a product could be processed utilizing a high speed fluid cut procedure. During the fluid cut the precise rate of cut need not be closely monitored or regulated, while still accomplishing a close, precise fit between mating components of the more intricately designed products. In addition, the type of solid material utilized in the formation of such products could vary widely and include various solids now commonly used in floor and other surface coverings, of the type set forth above.

### SUMMARY OF THE INVENTION

The present invention is directed towards a surface covering such as, but not limited to a covering surface for a floor, wall, etc. In addition, a surface covering assembly of the present invention is structured to have sufficient structural integrity to have a long operable life while at the same time being decorative so as to enhance the overall appearance of the area or physical environment surrounding the surface covering assembly.

In addition, the surface covering assembly of the present invention includes a base which may have any number of peripheral configurations including its peripheral edge formed into a circle, multi-sided figure or any other substantially regular or irregular shape. In order to enhance the decorative, aesthetic appearance of the surface covering assembly, it may include one or more inlay sections mounted thereon such that the inlay section and the exposed face are concurrently viewable when the surface covering assembly is disposed in its intended, operative position, such as when it is used as a floor covering, wall covering, etc. Therefore, an important feature of the present invention is the structuring of the surface covering assembly and the inclusion in its method of formation, such that peripheral edges of the base as well as the inlay section are formed using a high pressure, jet fluid stream commonly utilized in fluid jet cutting techniques for the formation of stone, granite, tile and like materials. More specifically, and as will be explained in greater detail hereinafter the structure of the surface covering assembly of the present invention is such as to allow the performance of the fluid jet cut at a relatively high speed, while still producing a precise fit or mating engagement between substantially confronting peripheral edges of the inlay section and base.

The various structural features of the surface covering assembly of the present invention which facilitate its formation, utilizing a high pressure fluid cut, comprises a base formed of stone or other applicable material. Regardless of the material utilized, the base is relatively thin, particularly as compared to conventional surface covering structures of the type generally set forth above. In addition, a backing is disposed in confronting relation to an undersurface of the base and preferably extends along substantially the entire undersurface. The backing may be secured or adhered directly to the under surface of the base or be disposed in the aforementioned covering and/or confronting relation thereto. In a general sense the backing is structured to be separable, particularly when exposed to a high pressure fluid stream used to cut and shape various portions of the base. As such, the backing preferably comprises an apertured construction extending over all or a significant portion thereof. In particular, at least one embodiment of the surface covering assembly of the present invention includes the apertured construction extending along and in corresponding relation to all or predetermined ones of seams formed in the base. In addition the apertured construction extends along the peripheral edges of the base which are cut and shaped by the aforementioned high pressure fluid stream used to perform of the fluid cut. Further, the backing may be formed of a flexible, relatively high strength material such as aluminum other metals, plastic, etc. However, the material, while durable and long lasting, will be prone to separate upon exposure to the aforementioned high pressure fluid stream.

Similarly, the inlay section is also formed from a rigid material of the type set forth above and also has a relatively thin transverse dimension which preferably corresponds to the thickness of the base. The inlay section also includes a backing secured to or disposed in confronting relation to the under face or undersurface of the inlay section. The backing of both the base and the inlay section are formed of the same or substantially equivalent material. Therefore, as with the base, the backing of the inlay section is separable along portions thereof which are exposed to the high pressure fluid jet forming a fluid cut in the inlay section.

In at least one embodiment of the present invention both the base and the inlay section include a covering layer secured directly to the outer most surface of the respective backings. The covering layer is preferably formed of a fiber glass or other equivalent material which is applied to the outer face of the backing in a malleable or substantially fluid state. When applied in this manner, the covering layer may protrude through the apertured construction of the backing and may or may not serve as a means for securing the backing to the under surface of the base and inlay section. Therefore, once cured or set, the covering layer serves to enclose or at least partially encase the backings thereby assuring that the they will be maintained in the aforementioned confronting relation to the under surface of both the base and the inlay section.

The method of forming and manufacturing the surface covering assembly of the present invention comprises disposing the backing in confronting relation to a source or supply slab of the material from which the base is cut. The aforementioned fluid cutting techniques are then applied to form the preferred, predetermined configuration of the outer peripheral edge thereof. Similarly, when an inlay section is to be mounted on or connected to the base, the inlay section, having the backing disposed in confronting relation to the under surface thereof, is also exposed to the high pressure fluid stream so as to shape the outer peripheral edge thereof into the predetermined configuration.

The mounting or attachment of the inlay section to the base is accomplished by the forming of an opening in the base, again through the application of the high pressure fluid cutting stream. The periphery of the formed opening corresponds and is substantially equivalent to the periphery of the inlay section such that precise mating engagement occurs there between as the inlay section is inserted into the equivalently configured opening of the base. The junction between the corresponding peripheral edges of the inlay section and the base may be defined as a continuous seam.

As indicated above, the formation of the peripheries and/or peripheral edges of both the base and the inlay section, being formed by the high pressure fluid stream, exposes the backing of both the base and the inlay section to the stream. Once so exposed, the stream will separate or cut the corresponding backings of the base and inlay section. The corresponding cut edges which are aligned with the seam and/or periphery or peripheral edges of the base and inlay section will thereby be forced into an outwardly directed or outwardly flared orientation. As explained in greater detail hereinafter, such an outwardly directed orientation of the separated edge portions of the respective backings will further facilitate corresponding peripheries of the inlay section and the base into an intended confronting relation to one another due at least in part to their respective reduced thickness.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front or top plan view of an assembled base and inlay section.

FIG. 2 is a schematic view, in section of the base of the surface covering assembly of the present invention.

FIG. 3 is a schematic view in cross section of the inlay section of the surface covering assembly of the present invention.

FIG. 4 is a front or top view of a backing associated with both the base and inlay section of the present invention.

FIG. 5 is a front or top plan view of the base having an opening formed therein for receipt of the inlay section.

FIG. 6 is a formed inlay section prior to its mounting within the opening of the embodiment of FIG. 5.

FIG. 7 is a sectional view in partial cutaway along lines 7-7 of FIG. 5.

FIG. 8 is a sectional view in partial cutaway along lines 8-8 of FIG. 6.

FIG. 9 is a sectional view in partial cutaway along lines 9-9 of FIG. 1.

FIG. 10 is a side view of a plurality of backed source slab elements disposed on a support platform.

FIG. 11 is a side view of the decorative surface covering illustrating its face up assembly.

Like reference numerals refer to like parts throughout the several views of the drawings.

### DETAILED DESCRIPTION OF THE PREFERRED EMBODIMENT

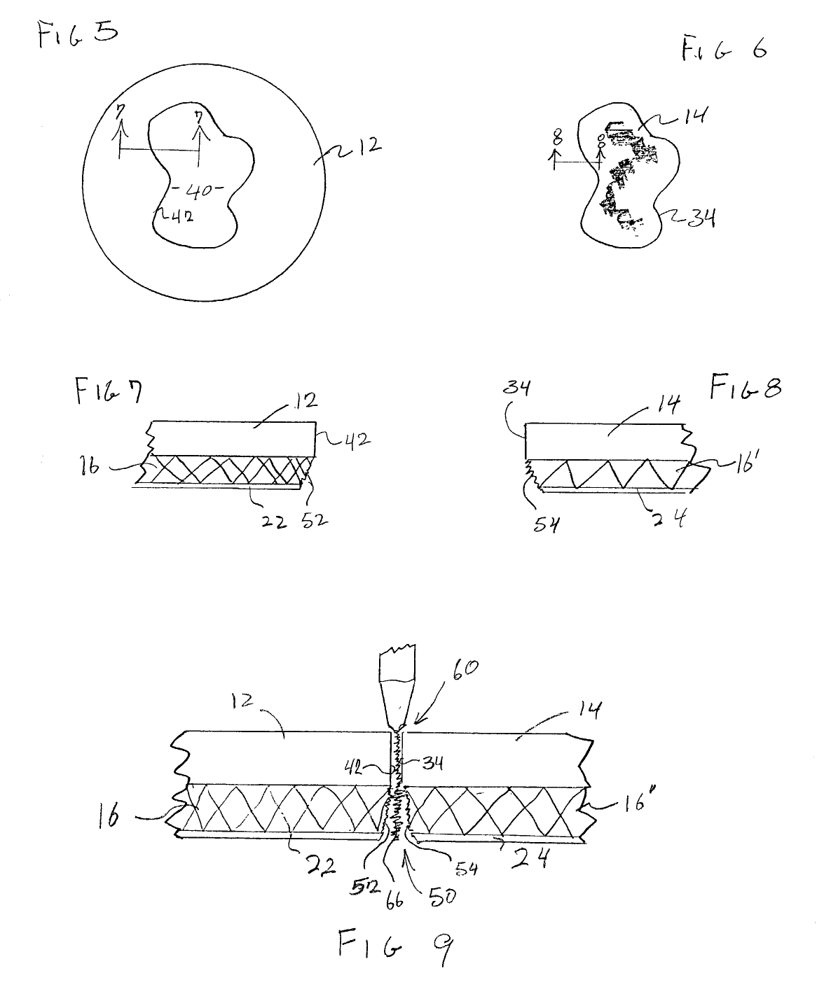

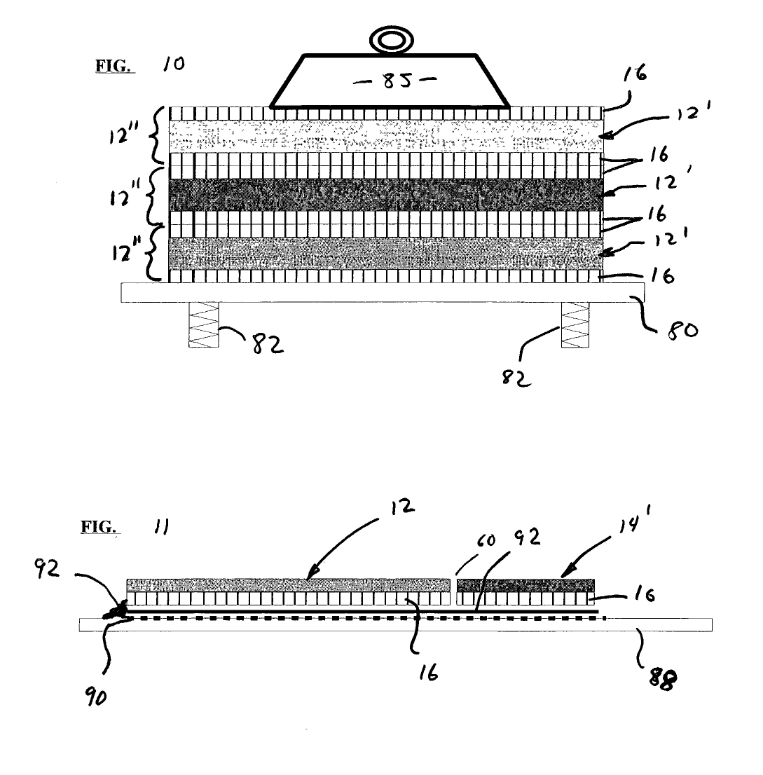

As shown in the accompanying drawings, the present invention is directed towards a surface covering assembly generally indicated as 10 and including a base 12 and a inlay section 14. The surface covering assembly 10 may be used as both a functional and decorative covering for flooring, wall surfaces and the like. It is emphasized that the surface covering assembly 10 of the present invention could be manufactured, formed and made commercially available with or without the inlay section 14 and be utilized for the same intended purpose. However, for purposes of clarity at least one preferred embodiment of the present invention comprises the surface covering assembly 10 including an inlay section 14. The method of forming and applying the inlay section 14 to the base 12 will be discussed in greater detail with primary reference to FIGS. 5 through 9.

With reference to FIGS. 2 and 3, the base 12 is formed from a supply or source slab or material indicated as 12′. The preferred and predetermine configuration, size, etc. of the base 12 is formed from the supply slab or structure 12′ utilizing at least partially conventional techniques associated with the cutting of stone like material by applying a high pressure fluid jet stream, generally referred to as fluid cutting. Therefore, while the overall shape of the base 12 may vary from the circular configuration shown in FIG. 1 to other regular, irregular and/or multi-sided configurations, the base 12 is formed from the supply slab 12′ using the aforementioned fluid cutting techniques. Similarly, the inlay section 14 is formed from a supply slab or like source structure 14′, wherein the specific, configuration, etc. of the inlay section 14 is cut from the supply slab 14′ also using the conventional fluid cutting techniques.

The surface cutting assembly of the present invention also includes a backing 16 disposed in confronting relation to an under surface 18 of the base 12. In certain embodiments, the supply slab 12′ also initially has the backing 16 secured thereto as shown in FIG. 2. Similarly the surface covering assembly 10 of the present invention includes the inlay section 14 as well as its source slab or structure 14′ also having a backing 16′ secured in confronting relation to the under surface or non-exposed face 20 of the inlay section 14. The backings 16 and 16′ may be secured to the respective under surfaces 18 and 20 in a directly attached or connected manner. Alternatively, the backings 16 and 16′ may be disposed in the aforementioned confronting orientation relative to the surface 18 and 20 through the provision of a covering layer 22 and 24. The covering layers 22 and 24 are respectively disposed in overlying, covering and at least partially enclosing or encasing relation to the respective backings 16 and 16′. The covering layer 22 and 24 may be formed from a fiberglass or like material and often includes a resin, sand or other surface texturing substance to prevent slippage. After the respective covering layers 22 and 24 are allowed to cure or set, they may pass through an apertured construction of the respective backings 16 and 16′. In doing so, the covering layers 22 and 24 nay serve as a means of attachment of the backing 16 an 16′ to the respective under surface 18 and 20 of the base 12 and inlay section 14 respectively. However, it is emphasized that in at least one embodiment of the present invention, a structure other than the covering layer 22 and 24 are used to attach or secure the backing 16 and 16′ to the base 12 and inlay section 14.

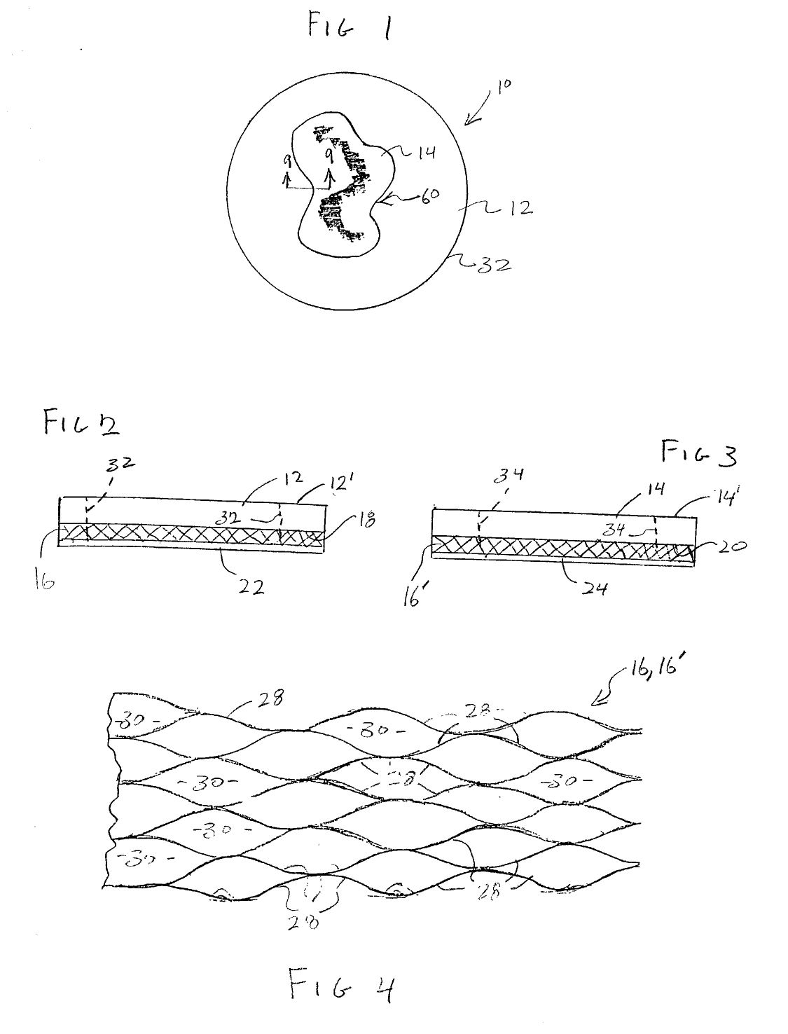

With reference to FIG. 4, the backing 16 and/or 16′ comprises an apertured construction which may comprise a screen-like structure including a plurality of segments 28 interconnected together so as to collectively define a plurality of openings or apertures 30. The backings 16 and 16′ are substantially equivalently structured and be formed of a flexible relatively high strength material, such as aluminum or other metals and/or high strength plastic materials. An important feature of the backings 16 and 16′, particularly including the material from which they are formed, is their ability or tendency to separate when they are exposed to the high pressure fluid stream used in the fluid cutting process. Separation occurs along the respective seams or peripheral edges indicated in phantom lines in FIGS. 2 and 3 as 32 and 34. The seams or peripheral edges are created when the high pressure fluid stream is used to define the configuration of the base 12 and the inlay section 14. Further, exposure of the backings 16 and 16′ to the high pressure fluid stream will result in an area of separation being formed which is generally indicated as 50 in FIG. 9. The area of separation 50 extends along the entire seam or respective peripheries or peripheral edges in either the base 12 or the inlay section 14 during their respective formations. As will also be discussed in greater detail hereinafter, the area of separation 50 is also, at least partially defined by an outwardly directed orientation of the separated portions or edges 52 and 54 of the respective backings 16 and 16′ when the pressurized fluid stream is applied thereto.

As set forth above, at least one preferred embodiment of the present invention comprises the provision of an inlay section 14 secured to the base 12. The inlay section may come from a different type of material and/or may have an obviously different appearance from that of the material from which the base 12 is formed. Accordingly, the overall decorative or aesthetic appearance of the surface covering assembly 10, incorporating an inlay section 14, may be greatly enhanced. The method of forming the assembled surface covering assembly 10, with the inlay section 14 included, comprises the formation of an opening 40 in the base 12. The opening 40 has a peripheral edge 42 as shown in FIGS. 5 and 7 which is substantially equivalent or at least corresponds to a significant extent, to the configuration of the peripheral edges 34 of the inlay section 14. As set forth above, the respective peripheries or peripheral edges 42 and 34 are formed using the fluid cutting techniques which are at least partially known in the industry. As also set forth above, exposure to the backing 16 and 16′ of the base 12 and inlay section 14 causes the peripheral edges 52 and 54 of the backings 16 and 16′, which were exposed to the high pressure fluid stream, to be directed or oriented inwardly. The inwardly directed peripheral edges thereby at least partially define a voided area of separation 50, as referred to above with reference to FIG. 9. Therefore, after the formation of the opening 40, the inlay section 14 may be added to the base 12 by disposing the corresponding peripheries 34 and 42 of the inlay section 14 and the opening 40 into aligned, confronting relation with one another. A seam 60 is formed and defined by the peripheries 34 and 42 disposed in confronting relation to one another.

Therefore, another feature of at least one embodiment of the present invention comprises the area of separation 50 being voided is at least partially defined by the inwardly flared or directed peripheral edges 52 and 54 of the backings 16 and 16′ being space from one another. A precise positioning of corresponding peripheries 34 and 42 of the inlay section 14 and opening 40 is thereby facilitated. Therefore, the rate of cutting of the high pressure fluid stream used in the fluid cutting procedure may be significantly increased in that the overall thickness of both the base 12 and inlay section 14 is reduced and the correspondingly disposed peripheral edges 52 and 54 of the respective backings 16 and 16′ flare away from one another so as to define the aforementioned area of separation 50.

In order to overcome any weakness or lack of structural integrity due to the relatively thin structuring of the base 12 and the inlay section 14, the voided area of separation 50 as well as at least a portion of the formed seam 60 is reinforced by forcing a fluid flow of epoxy between the confronting peripheries 34 and 42 and into the area of separation 50. The area of separation 50 is substantially filled by the epoxy 66 once it cures or sets. The reinforcing material or epoxy 66 may be defined by a any of a number of different compositions. However, a general description of the epoxy or material used may include any of a plurality of various thermosetting resins capable of forming tight cross-linked polymer structures characterized by relatively high strength, toughness and strong adhesion. Once applied, the reinforcing epoxy or like filler material 66 serves to add strength or overall structural integrity particularly in the area of the seam 60 and along its length. A significant amount of force or weight applied to the base 12 and/or inlay section 14, particularly in the area of the seam 60 will not result in breakage or structural failure of either the base 12 or the inlay section 14 due to the high strength reinforcing characteristics of the filler material or epoxy 66. The types of force the area of the seam 60 is subjected, particularly when the base and inlay sections 12 and 14 are used as a floor covering, would typically be applied by “high-heal” shoes available in a variety of styles and popularized as women's foot wear for many years.

Looking to yet another embodiment of the present invention, a further improved method of making a surface covering structure may be defined. In particular, in this embodiment, a source slab 12′ is first secured to a backing material 16. As recited, the backing material 16 is preferably defined from aluminum or another strong, at least semi rigid material, and is preferably formed into a honeycomb type configuration with a fiberglass or other material covering layer 22. The covering layer, in such an embodiment helps maintain the integrity of the backing material layer 16 despite its open configuration, and is preferably presecured to the backing material layer 16.

In this alternate embodiment, at least two backing material panels 16 are provided and are secured, preferably via an adhesive material such as epoxy, to opposite faces of the source slab 12′, thereby defining a backed source slab element 12″. Moreover, in order to more effectively secure the backing material panels 16 to the opposite faces of the source slab 12′, the backed source slab element 12″, and preferably a plurality of backed source slab elements 12″ are disposed on a support platform 80, with a load 85 being disposed atop the backed source slab elements 12″. Furthermore, the platform 80 is preferably moveable, such as by being disposed on a series of shock absorbent elements 82, the overall configuration being subjected to a vibrational force for a period of time such that the backing material panels 16 are more effectively secured to the source slab 12′ under the weight of the load 85 and/or other backed source slab elements 12″.

The secured backed source slab element 12″ is then preferably cut into two slab segments preferably using a wire saw or similar device. The cut is preferably achieved by cutting a longitudinal or latitudinal planer cut through the center of the source slab 12′, thereby resulting in the formation of two substantially similar slab segments, each having one backing material panel 16 adhered to the source slab 12′. Of course, the remaining thickness of source slab 12′ adhered to the single backing material panel 16 will be approximately one quarter the thickness of the original source slab. This combination slab segment of the source slab 12′ with the secured backing material panel 16 can then be cut, such as using the fluid cutting previously recited, so as to define a specific design element, such as the base 12 of the illustrated embodiment. In this regard, it is noted, that the same procedure is preferably utilized in the formation of the inlay slab 14′, which is also adhered to a single backing material panel 16. Furthermore, in many designs, multiple different material slabs are used to form a detailed design, with all segments are inlayed at least partially within an overall design. For purposes of clarity within the present description, however, only two slab elements identified as a base 12 and an inlay 14 are cut and inlayed with one another, however, it is understood that many such slab segments can be used, such as defining a series of inlay segments or base segments, and the base 12 need not completely border or enclose the overall surface covering structure 10, but may merely define a portion(s) thereof in combination with one or more inlay segments 14. As such, the terms base and inlay are used merely to distinguish slab segments from one another in a design that may include multiple base segments to comprise the base and/or multiple inlays which may or may not completely enclose one another. It is also noted that the fluid cutting can be achieved at a significantly increased rate, in some embodiments as much as 600%-800% faster, due to the thin nature of the stone, marble, granite, etc. that makes up the main face of the base and inlay. By way of example, when the source slab includes marble, the cut can be made at 80-100 inches per minute.

Once the base 12 and inlay 14 are formed, they are inlayed with one another on a support surface 88. In preparation for inlaying, a fiberglass mesh 90 is placed on the support surface 88, and/or a plastic or other material covering on the support surface 88. An epoxy resin and sand mixture 92 is then applied over the fiberglass mesh 90. Specifically, this epoxy resin and sand mixture provides for adhesion between the fiberglass mesh 90 and the bottom surface of the base 12 and inlay 14, which in this embodiment includes the covering layers 22 and 24 of the base 12 and inlay 14, but also provides a surface that more effectively bonds to concrete and/or other surface materials at an ultimate installation site of the surface covering structure 10.

With the fiberglass mesh 90 and the resin and sand mixture 92 in place the base 12 is then preferably positioned so that the covering layer 22 contacts the fiberglass mesh and is adhered thereto by the resin and sand mixture 92. As indicated, the base 12, which in the preferred embodiment forms the perimeter of the surface covering structure 10, may be formed from one or multiple segments. Once the base 12 is positioned, a layer of epoxy, and preferably the epoxy and sand mixture 92 around an exterior perimeter of the base 12, preferably at least at the base's contact with the underlying surface. The one or more inlays 14 are then positioned so as to define a desired, attractive pattern, also with the covering layer 24 disposed on the fiberglass mesh. Also preferably the inlays are positioned such that equal sized seams 60 are defined between adjacent segments. During this process it is noted that at least partially as a result of the backing material layer, a substantially thin yet manageable material segment can be formed. Indeed, the manageability of these segments, either inlay or base, substantially reduces the production time and loss of components due to breakage. For example, cracked material can be used with minimal waste, and less delicate handling is required to produce an article that is thin enough, typically no more than ⅜ inch, to fit in with a regular tile floor, while strong enough to form part of a floor or table surface. Nevertheless, the decorative surface covering 10 can be quite detailed and attractive, resembling a solid stone article, but with more versatility and more economical.

With the base and inlay properly positioned, an adhesive, such as an epoxy is introduced into the seams 60 so as to secure the segments with one another. Further, by assembling the segments “face up”, the backing material layers of each segment, which are preferably the same thickness, will be generally vertically aligned with one another atop a level support surface, and securement by the epoxy will effectively bond them to one another. Any vertical overlap of the base or inlay at the top, exposed layer can be ground down to make a uniform finish whereafter polishing takes place to develop the finished product.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method of forming and assembling a surface covering structure, said method comprising:
a) applying a first open-mesh backing to an undersurface of a base and a second open-mesh backing to an under surface of an inlay section,
b) forming an opening having a periphery of a predetermined configuration within said base,
c) forming a periphery of said inlay section into a predetermined configuration corresponding to the periphery of said opening,
d) forming an area of separation within each of said first and second backings adjacent to the respective peripheries of the opening and the inlay section, and
e) securing the inlay section within the opening in an inlaid position relative to the base.

2. A method as recited in claim 1 comprising forming the area of separation concurrently to forming the peripheries of the opening and the inlay section.

3. A method as recited in claim 2 comprising forming the area of separation and the respective peripheries of the opening and the inlay section by directing a high pressure fluid stream thereon.

4. A method as recited in claim 3 comprising disposing edge portions of the first and second backings in an outwardly directed orientation relative to the respective peripheries of the opening and the inlay section.

5. A method as recited in claim 4 comprising defining a voided area between correspondingly positioned edge portions of said first and second backings when said inlay section is secured within the opening.

6. A method as recited in claim 5 comprising disposing a reinforcing composition within the voided area in at least partially supporting relation to portions of the base and the inlay section adjacent respective peripheries of the opening and the inlay section.

7. A method as recited in claim 1 comprising disposing edge portions of the first and second backings in an outwardly directed orientation relative to the respective peripheries of the opening and the inlay section.

8. A method as recited in claim 7 comprising defining a voided area between correspondingly positioned edge portions of said first and second backings when said inlay section is secured within the opening.

9. A method as recited in claim 8 comprising disposing a reinforcing composition within the voided area in at least partially supporting relation to portions of the base and the inlay section adjacent respective peripheries of the opening and the inlay section.

10. A method of forming a decorative surface covering comprising:
a) securing a backing material panel to a first and a second face of a first source slab so as to define a first backed source slab element and to a first and a second face of at least a second source slab so as to define at least a second backed source slab element;
b) making a planer cut through said first source slab of said first backed source slab element, so as to define two first slab segments, and through said second source slab of said second backed source slab element, so as to define two second slab segments;
c) cutting a predefined pattern in at least one of said first slab segment so as to define a base segment;
d) cutting a predefined pattern in at least one of said second slab segments so as to define at least one inlay segment;
e) positioning said base segment on a support surface;
f) disposing said inlay segment on said support surface in inlayed relation to said base segment;
g) applying a quantity of an adhesive material between said inlay segment and said base segment so as to secure said inlay segment and said base segment with one another to define the decorative surface covering.

11. A method as recited in claim 10 further comprising:
applying an adhesive between said first source slab and said backing material panels, positioning at least said first backed source slab element on a support platform, positioning a load on at least said first backed source slab element, and vibrating said first backed source slab element for a period of time so as to further secure said backing material panels to said first source slab.

12. A method as recited in claim 11 comprising positioning a plurality of backed source slab elements atop one another on said support platform.

13. A method as recited in claim 10 comprising making said planer cut through at least said first backed source slab element utilizing a wire saw.

14. A method as recited in claim 10 further comprising cutting a predefined pattern in a plurality of slab segments so as to define a plurality of inlay segments.

15. A method as recited in claim 10 further comprising disposing a side of said base segment having said backing material panel thereon on said support surface so as to maintain a uniform vertical orientation of said backing material panel relative to adjacent pieces thereof.

16. A method as recited in claim 15 further comprising positioning a fiberglass mesh and an adhesive material on said support surface, and disposing said base segment thereon.

17. A method as recited in claim 15 further comprising applying an adhesive around an exterior perimeter of said base segment generally at an engagement point with said support surface so as to prevent subsequent seepage of fluid from beneath said base segment.

18. A method as recited in claim 17 further comprising forming a plurality of said base segments and arranging said plurality of base segments on said support surface so as to define a base into which at least one of said inlay segments may be disposed.

19. A method as recited in claim 15 further comprising disposing a side of said inlay segment having said backing material panel thereon on said support surface so as to maintain said uniform vertical orientation of said backing material panel relative to adjacent pieces thereof, and grinding an upper surface of said base segment and said inlay segment so as to achieve a substantially uniform upper surface to the decorative surface covering.

20. A method of forming a decorative surface covering comprising:
a) securing a backing material panel to at least one face of a plurality of source slabs and defining a plurality of slab segments each having a first side comprising said source slab material and a second side comprising said backing material panel;
b) cutting at least one base segments and a plurality of inlay segments, each having a predefined pattern, from at least two of said slab segments utilizing a fluid cutting system;
c) positioning said base segment with said second side down on a support surface so as to define a base;
d) applying an adhesive material around an exterior perimeter of said base so as to prevent fluid seepage from beneath said second side of said base;
e) disposing said inlay segments on said support surface with said second side down in inlayed relation to said base such that said backing material panel of said inlay segments and said base are generally vertically aligned;
f) contouring said first side of said base and said inlay segments so as to produce a substantially uniform surface height therebetween; and
g) applying a quantity of an adhesive material between said inlay segments and said base so as to secure said inlay segments and said base with one another to define the decorative surface covering.

21. A method as recited in claim 20 further comprising positioning a fiberglass mesh and an adhesive material on said support surface, and disposing said base segment thereon.

22. A method as recited in claim 21 further comprising positioning an adhesive material containing a coarse material therein on said support surface so as to facilitate adhesion of the decorative surface covering to an underlying support surface.
